(19) United States
(12) Patent Application Publication
(10) Pub. No.: US 2008/0237337 A1
(43) Pub. Date: Oct. 2, 2008

(54) STAKEHOLDER CERTIFICATES

(75) Inventors: Christopher W. Drackett, Chicago, IL (US); Deborah W. Matteo, Schaumburg, IL (US); Steven Nowlan, South Barrington, IL (US); William F. Zancho, Hawthorn Woods, IL (US); Jon Godston, Chicago, IL (US); Kenneth W. Douros, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/694,576

(22) Filed: Mar. 30, 2007

(51) Int. Cl. G06K 5/00

(52) U.S. Cl. 235/380; 700/90

(57) ABSTRACT

An electronic device (130) uses a record (122) which defines capabilities desired for the electronic device. The requirements of one or more stakeholders are entrusted using stakeholder priority certificates (136). Signatures in the stakeholder priority certificates are authenticated by a device (130). A processor compares components (140) of the electronic device against the received record (122) and the trusted stakeholder requirements to determine operation characteristics of the electronic device (130). The processor can execute a conflict resolution process (133) to resolve conflicts among stakeholder requirements such as arbitrating among at least two of the stakeholders. The processor can resolve conflicts among the stakeholder requirements using a predetermined priority sequence (135).

### RELATED APPLICATIONS

This application is related to applications being filed concurrently with the USPTO, and assigned to the assignee hereof, identified as: “THEME RECORDS DEFINING DESIRED DEVICE CHARACTERISTICS AND METHODS OF SHARING”, attorney docket number CML04619HISTR; and “STAKEHOLDER CERTIFICATES”, attorney docket number CS27780STARS.

### TECHNICAL FIELD

The present inventions relate to electronic devices and systems and, more particularly, relate to trusted customization thereof.

### BACKGROUND OF THE INVENTIONS

Systems have been used for customizing computers and mobile telephones. Typically these systems provided for user level preference settings such as display language, alert settings, service level (such as media bandwidth) and font, within limitations defined by a service provider or the user, or a manufacturer, etc., and combinations thereof. However, conflicts between the entities that affect preference settings can cause extra work and complexity for the user.

Furthermore, when customizations are made, requests and authorizations may not originate from a legitimate source. What is needed is the ability to gain confidence in the legitimacy of an entity who determines a requirement.

Advanced systems and devices for determining and setting customizations are needed that provide for customizations in a trustworthy manner.

### BRIEF DESCRIPTION OF THE DRAWINGS

Details of the inventions will be more readily understood from the following detailed description when read in conjunction with the accompanying drawings wherein:

FIG. 1 illustrates a schematic block diagram of a system according to some embodiments of the present inventions;

FIG. 2 illustrates a schematic block diagram of an electronic device according to some embodiments of the present inventions;

FIG. 3 illustrates a schematic block diagram of an exemplary stakeholder certificate according to some embodiments the present inventions;

FIG. 4 illustrates a schematic block diagram of an exemplary stakeholder requirements table according to some embodiments of the present inventions;

FIG. 5 illustrates a schematic block diagram of an exemplary components database according to some embodiments of the present inventions; and

FIG. 6 illustrates a flow diagram of a process for implementing a new stakeholder certificate having priorities for device configuration according to some embodiments the present inventions.

### DETAILED DESCRIPTION OF THE PREFERRED EMBODIMENTS

Electronic devices and portable electronic devices, such as mobile telephones or portable computers, have various components, features or attributes available for use. These components need to be chosen. When customizations are made, requests and authorizations may not originate from a legitimate source. What is needed is the ability to gain confidence in the legitimacy of an entity who determines a requirement before determining and setting customizations in an electronic device. The embodiments of the present inventions provide for selection in a trustworthy manner.

The user of an electronic device as well as the manufacturer of the electronic device, the service provider for the electronic device, the seller of the electronic device, and the application or software provider of the electronic device are all stakeholders which may desire influence over a chosen configuration. Besides the user, the device manufacturer, the service provider, the seller of the electronic device, and the application provider, an application developer, a content owner, and an environment location owner can also be a stakeholder which may desire influence over a chosen configuration.

When a stakeholder influences the choice, it is important that the stakeholder is legitimate and authorized. Otherwise non-payment for characteristics such as applications or services is possible through fraud or misrepresentation.

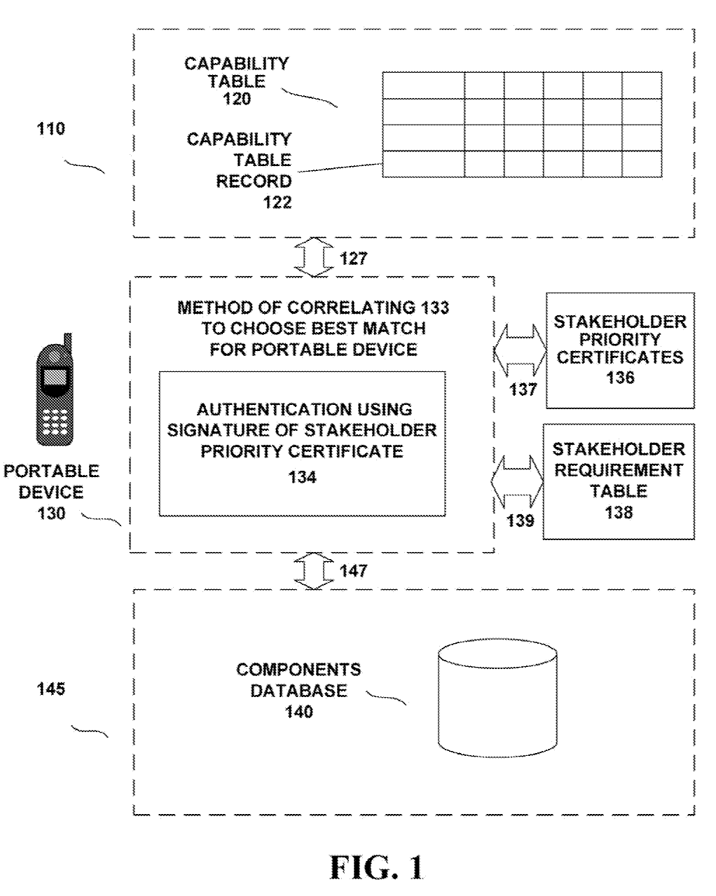

FIG. 1 illustrates a schematic block diagram of a system according to some embodiments of the present inventions. Stakeholder priority certificates 136 contain a signature and stakeholder priority data. A processor of the portable device 130 performs an authentication 134 to assure that the stakeholders are legitimate and authorized by checking the signature on each of the stakeholder requirements certificates against a trusted list of stakeholder signatures. A processor can also perform a correlation 133 and conflict resolution process to determine the operation characteristics of the portable electronic device.

A capability table 120 holds a plurality of capability table records. Each capability table record is a candidate for a portable device 130. The capability table 120 is stored in memory 110. A given capability table 120 defines recommended characteristics of user interface categories to be established for various capabilities of a device. These characteristics can be sets of capabilities, features or attributes desired for the electronic device. An electronic device uses one or more capability table records from the table 120 to define capabilities, features or attributes desired for the electronic device. The attributes might be user interface elements. Example capabilities are alert, keys, text, video and image. The values for each characteristic defined in the capability record table 120 are values such as on or off, list selections, numbers or ranges.

The capability table 120 of FIG. 1 contains a plurality of capability table records 122. Each capability table record 122 provides a device such as the portable electronic device 130 of FIG. 1 with information defining desired characteristics for the device. The desired characteristics can be expressed in each capability table record with one or more characteristic descriptions, wherein each of the characteristic descriptions defines desired characteristic for a plurality of user interface categories of a plurality of capabilities of a device.

A characteristic can define a desired persistence, for example, of an alert or a key press. The ranges can be defined by a desired maximum and minimum range of characteristics for one or more user interface elements. A discrete value can defines a desired characteristic for one or more user interface elements. At any given time, although there may be only one capability table record 122 for the processor of the device 130 to correlate, typically a device 130 will be presented from the capability table 120 with many capability table records 122. When the processor faces multiple capability table records 122, the correlation method 133 decides which attributes to use. In one approach, the correlation method 133 combines discrete capability table records to find attributes common to the capability table records 122 of the table 120. In another approach, in the case of a capability table record 122 with ranges, the correlation method 133 combines ranges of the capability table records to find ranges that are common to the capability table records 122 of the table 120.

The correlation method 133 can correlate the desired characteristics in the capability table records 122 with a components database 140. By correlating the desired characteristics for a device with the available components in a device, a configuration is determined for the portable device 130. This correlation gives the characteristics “wish list” a “reality check” as to the available components on a device. Stakeholder requirements can also be added to this correlation to further filter or prioritize the configuration choices, and signed certificates used for trust, as will be described below.

Each portable device 130 is associated with a components database 140. The components database 140 may be stored in memory 145 which can be the memory of the portable device 130, depending on a chosen system configuration. The components database 140 is coupled to the portable device 130 at 147. The components database 140 contains lists of the components available in the portable device 130. The components database 140 also lists, for each component, capabilities of that component. For example, a camera component would have its capabilities define the kinds of images producible by the camera such as mpeg or jpg.

Depending on the level a user has purchased from a service provider, from a manufacturer, from an application provider, from a software provider, or from other stakeholders, the capabilities of the components may or may not be chosen or enabled in the electronic device. Further, the user may be considered to be a stakeholder and may desire his or her own level of certain components within the electronic device.

A portable electronic device 130 such as a mobile telephone has its operation characteristics (the values of features, capabilities or attributes used in operation) selected by use of the available capability table records. The capability table record 120, the components database 140, a stakeholder requirements table 138 and stakeholder priority certificates 136 may be used for this selection. The capability table 120 is also coupled to the portable device 130 at 127.

Stakeholder priority certificates 136 hold stakeholder priority codes for applications and also hold an authentication signature. The stakeholder priority certificates 136 are coupled to the portable device 130 at 137. The stakeholder priority certificates 136 are delivered to the portable electronic device for storage in memory therein by modem over a network or via other mechanisms such as Bluetooth, IR or on a smart or SIM card.

A stakeholder requirements table 138 holds stakeholder priority sequences. The stakeholder requirements table 138 is coupled to the portable device 130 at 139. These stakeholder priority sequences can be derived from the stakeholder priority certificates 136. The processor of the portable device 130 can derive these stakeholder priority sequences for the stakeholder requirements table 138 by collecting the priority codes from the stakeholder certificates and ranking the stakeholders relative to one another.

The portable electronic device 130 checks the authentication signatures in the stakeholder priority certificates 136 to ensure that the priorities are authorized before implementing the determined characteristics for the device 130.

Characteristics for the device 130 are determined using a correlation method 133 to negotiate operation characteristics of the electronic device. The correlation is preferably performed by the device 130 using the priority entries in the stakeholder requirements table 138 and the capability table 120 ands components database 140.

The embodiments of the present inventions provide methods for negotiation of operation characteristics of the electronic device based on trusted stakeholder priorities. The method 133 assures stakeholder requirements are authorized to eliminate fraud or theft of unauthorized device features. The method 133 also determines operation characteristics of the electronic device by correlating one or more of the capability table records 122 with the component database 140 for a portable device 130, and using stakeholder priorities from a stakeholder requirements table 138 to resolve any conflicts that arise from the correlation. These priorities use a stakeholder certificate for trusted capability selection for the components of the portable device.

An example use is the characteristics selection for the components of a mobile phone based on a purchased subscriber levels. The purchased subscriber level may be indicated within the stakeholder priorities for a particular end user or device.

The correlation between the records of the capability table 120 and the components database 140 can be a matching process followed by thresholding. After the thresholding, conflict resolution can be applied.

An example of one matching process is to take the vector dot product on the rows of the table against the database. This is then followed by thresholding to select the best matching rows that are above a certain threshold. The rows above the threshold are then run through the conflict resolution process 133 and authorized and ranked based on the stakeholder.

A first embodiment of the correlation of the method 133 uses stakeholder priority based conflict resolution. In this approach, the combination of capabilities is cast as a constrained linear optimization problem with the constraints ordered according to the stakeholder priorities. There are a number of well known methods in the literature for solving these types of constrained optimization problems, including linear programming, simplex methods and convex hull methods. Examples can be found in Principles of Operations Research, H. M. Wagner, 1975. In all of these methods, the basic approach is to minimize some measure of dissatisfaction, which is a weighted combination of the degree of dissatisfaction of all of the constraints. Constraints determined by high priority stakeholders are assigned higher weights and are thus more likely to be resolved early. The optimization method will proceed until a global minima is found. The general method allows constraints to be defined in terms of continuous ranges of values, but a simplification is to allow each constrained to simply be represented by a binary variable which is 0 if the constraint is satisfied and non-zero otherwise. For this special case, binary programming can be used which is a more efficient form of optimization algorithm.

A second embodiment of the correlation of the method 133 uses filter, or category, based conflict resolution. This is a simpler, but much more efficient to implement form of conflict resolution. It is not in general guaranteed to provide an optimal solution, but it does guarantee that the constraints of the highest priority stakeholder are completely met, and as many non-conflicting constraints of subsequent stakeholders are met as possible.

The approach is fairly simple, and can be illustrated by considering a particular example. Imagine that there are three stakeholders, a service provider, a location owner and the device owner. The service provider has a requirement that emergency messages which it transmits to an end-user device must create an audible ring of at least level 3 (assume we have 10 volume levels for illustration). Currently the user is in a restaurant which requires any audible ring to be of a maximum volume of 4. Finally, our user is suffering some hearing loss, and has a preference that any audible ring be of at least level 5. We assume here that the priority ordering of stakeholders is that the service provider has highest priority and the end user lowest priority. The constraint of the first stakeholder says that the volume must be greater than or equal to 3, so any value from 3 to 10 is valid after considering this stakeholder. The second stakeholder adds a constraint of volume less than or equal to 4. So “anding” these two constraints we have the volume must be greater than or equal to 3 and less than or equal to 4. An audible ring level of 3 or 4 allows the constraints of both the first and second stakeholder to be met. The constraint of the third stakeholder is incompatible with the constraint of the second stakeholder, so it will not be satisfied and the combination of constraints stops at this point. If you think of each constraint as being a filter on allowed values of a variable, then we are combining together these filters as long as they are compatible with each other, until we have the tightest filter possible.

The negotiation or correlation method 133 can be performed in the portable device 130 or alternatively on a server in its network or system.

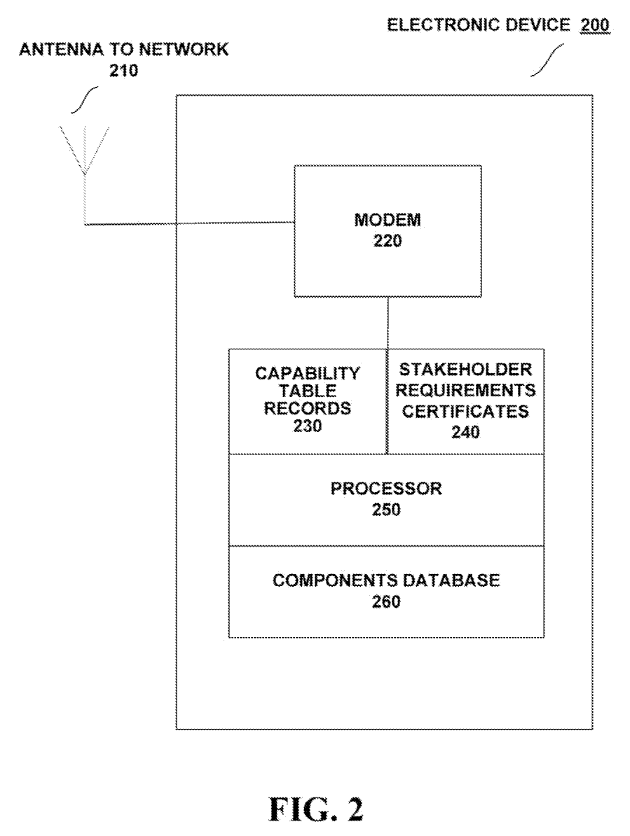

FIG. 2 illustrates a schematic block diagram of an electronic device 200 according to the present inventions. A modem 220 such as a radio transceiver is coupled to an antenna 210. The modem 220 communicates with a processor 250. The modem 220 preferably receives capability table records 230 and stakeholder requirements certificates 240, perhaps over a network to store in a device memory for the processor 250. The processor 250 is capable of deriving the stakeholder requirements tables from the stakeholder requirements certificates.

The processor 250 also assures that the stakeholders are legitimate and authorized by checking the authentication signature on each of the stakeholder requirements certificates 240. Non-payment for characteristics such as applications or services through fraud or misrepresentation can thus be prevented.

Further, the processor 250 has access to the components database 260 of the electronic device 200. The components database 260 is typically established in the electronic device 200 at the time of its manufacture, but could be downloaded or updated over the modem 220. Also, the capability table records 230 and stakeholder requirements 240 could be established by the electronic device 200 rather than received from the network over the modem.

The processor 250 can perform a correlation within the electronic device 200 to determine the operation characteristics using one or more capability table records 230, the components database 260 and the stakeholder requirements 240. The processor 250 can execute a conflict resolution process to resolve conflicts among stakeholder requirements such as arbitrating among at least two of the stakeholders or using a stakeholder requirements table. The processor 250 can override the stakeholder requirement of the stakeholder requirements table. The capability table record 230 can comprise the stakeholder requirements table.

Although a radio transceiver and antenna is illustrated for the electronic device 200 of FIG. 2, an antenna is not necessary and a wired network connection can be used instead. Further, the electronic device 200 can be any electronic device such as a laptop, personal digital assistant (PDA), portable gaming unit, camera, multimedia player, set top box or cellular telephone. The electronic device may be one of a cellular telephone, a multimedia player, a portable gaming unit, camera, and a Personal Digital Assistant (PDA).

Although some of the tables may be described above as being stored in the electronic device, the tables can alternatively be stored on a server connected over the network to the electronic device. Furthermore the processor for performing the stakeholder decisions can either access the records over the network or could itself also be located on a server and deliver the decisions over the network to the portable electronic device.

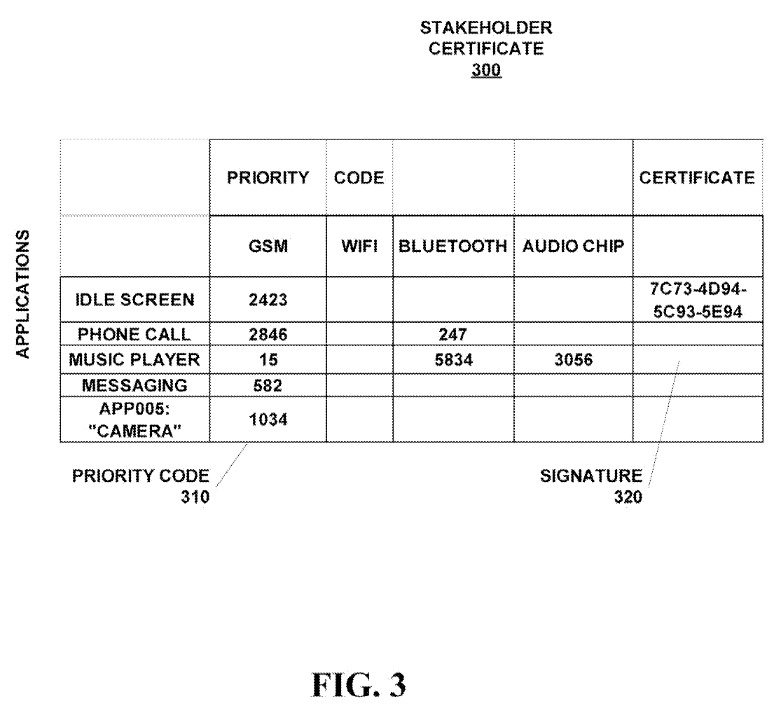

FIG. 3 illustrates a schematic block diagram of an exemplary stakeholder certificate according to some embodiments of the present inventions. Stakeholder priority certificates hold stakeholder priority codes for applications and also hold an authentication signature. For each application, a priority code 310 is given. Also, the stakeholder certificate 300 contains an authentication signature 320.

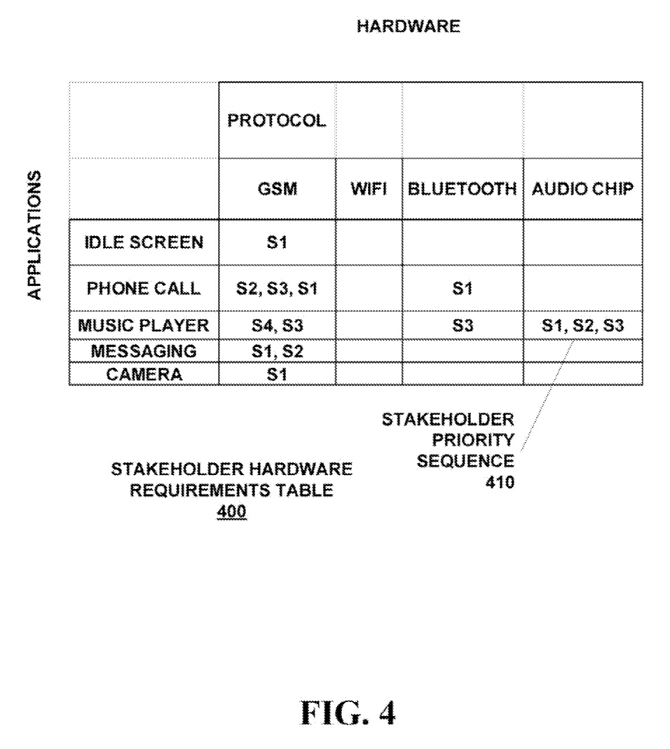

FIG. 4 illustrates a schematic block diagram of an exemplary stakeholder requirements table according to some embodiments of the present inventions. This exemplary stakeholder requirements table contains data indicative of the stakeholder priority sequence 410 for each capability of the electronic device.

Exemplary hardware features are illustrated in FIG. 4 for applications on the electronic device. Various hardware protocols such as GSM, WiFi, Bluetooth and audio chip are illustrated in the stakeholder hardware requirements table of FIG. 4. Different applications such as idle screen, phone call, music player and camera are illustrated along the other axis of the stakeholder hardware requirements table of FIG. 4. Other hardware applications can be covered such as various output protocols (e.g., visual LCD and LED) and other applications such messaging. Additionally software features can be covered such as GSM, Java, and universal plug and play UPNP, for example, as well as various output and input protocols such as visual, audible, haptic and smell

In the representation of the example in FIG. 4, each stakeholder has a stakeholder number S1, S2, S3, S4, etc. The stakeholder requirements table 400 defines priorities for each of a plurality of the stakeholders. The priority of each stakeholder relative to other stakeholders is illustrated by the priority sequence of the stakeholders in the exemplary table by the order in which the stakeholder numbers are placed.

The stakeholder priority sequences 410 illustrated in the example of FIG. 4 can be derived from the stakeholder priority certificates 300. The processor of the device can derive the sequences in this table by collecting the priority codes 310 from the stakeholder certificates and ranking the stakeholders relative to one another in the illustrated order.

The priority numbers for the stakeholders define which hardware features apply to which applications in what stakeholder priorities. Thus, the stakeholder software requirements table of FIG. 4 can be correlated against the capability table records and the components database to determine the features to implement for the electronic device. In the case of a conflict between the desires of stakeholders, the stakeholder priority is used in the correlation process to resolve the conflict and choose the features to implement.

Values can be received over the network from a service provider to store in a stakeholder requirements table. The values of the stakeholder requirements table can be determined based on a degree of service provider subsidy. They can be set initially on service provider setup and then altered upon subsequent setup changes initiated by the service provider.

According to an alternate embodiment stakeholder requirements can be expressed using a stakeholder filter. In this an alternate embodiment, when a feature is assessed such as upon a request, the feature is passed through a series of the filtering constraints. The filtering constraints define whether a feature is allowed. The filter constraints generally act as AND gate to require all constraints are met. An override filtering constraint acts as an OR gate to allow a feature regardless of whether the other constraints are met. Priorities for each of a plurality of the stakeholders are resolved using this alternate table. By establishing the filter constraints for each feature and needs of the stakeholders, this alternate table representing a method for making these decisions is provided.

To implement this alternate embodiment, the valid stakeholder certificates are ANDed together to provide the allowable applications in a rank determined by the processor using the priority codes for each stakeholder in each stakeholder certificate.

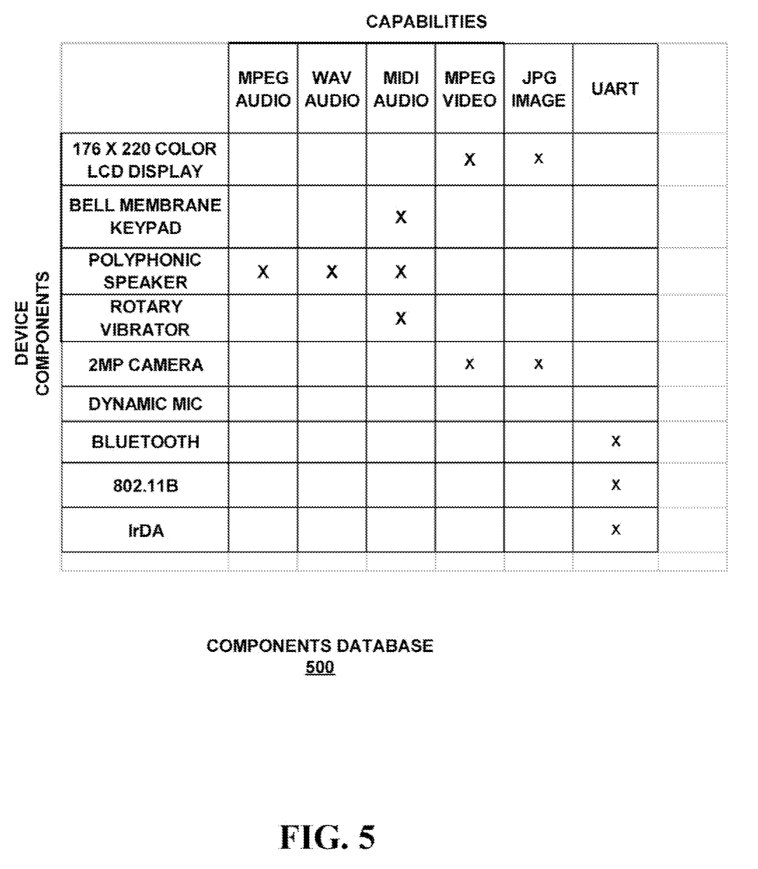

FIG. 5 illustrates a schematic block diagram of an exemplary components database 500 according to some embodiments of the present inventions. The components database defines the capabilities of a given electronic device, based upon an intersection of the components resident in a given device and the capabilities of each component. A camera component, for example, would have its capabilities defined as the kinds of images producible by the camera such as mpeg or jpg. A display component, for example, would have its capabilities defined as the kinds of images producible by the display, such as jpg and mpeg images, and also the kinds of audio, such as wav and mpeg audio. A keypad component could have its capabilities defined, for example, as the one or more kinds of audio produced for key click feedback.

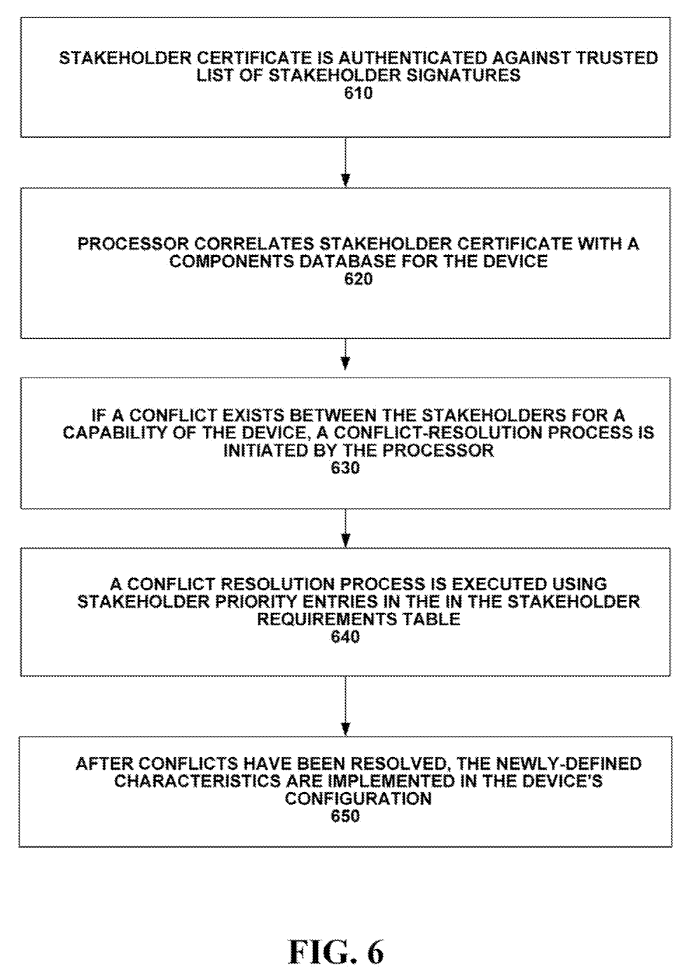

FIG. 6 illustrates a flow diagram of a process for implementing a new stakeholder certificate having priorities for device configuration according to some embodiments the present inventions. At step 610, the device receives a new stakeholder certificate and authenticates its signature against a trusted list of stakeholder signatures. A processor, on the device or on network server, correlates data in the received stakeholder certificate (such as stakeholder priorities) with a components database for the device at step 620. The processor can correlate by first performing a matching process and second subsequently thresholding. If a conflict exists between stakeholders for a configuration of the device, a conflict-resolution process is initiated by the processor at step 630. A conflict resolution process is executed using stakeholder priority entries in the in the stakeholder requirements table at step 640. This conflict resolution process can use either the first embodiment of a stakeholder priority based conflict resolution or the second embodiment of a stakeholder requirements filter. After conflicts have been resolved, the newly-defined characteristics are implemented in the device's configuration at step 650.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. An electronic device capable of using a stakeholder priority certificate, the stakeholder priority certificate defining stakeholder requirements for attributes on the electronic device, said electronic device comprising:
a memory for storing the stakeholder priority certificate including an authentication signature; and
a processor operatively coupled to the memory for authenticating the stakeholder priority certificate using the authentication signature and for comparing capabilities of the electronic device against the received stakeholder priority certificate to determine operation characteristics according to the stakeholder priority certificate.

2. An electronic device according to claim 1, wherein each stakeholder priority certificate comprises a signature corresponding to one stakeholder and comprises priority information for that one stakeholder.

3. An electronic device according to claim 1, wherein the stakeholder priority certificate comprises a signature signed by a certification authority.

4. An electronic device according to claim 1, wherein the stakeholder priority certificate comprises a priority among stakeholders.

5. An electronic device according to claim 1, wherein attributes are user interface elements.

6. An electronic device according to claim 1, wherein the stakeholders are selected from the group consisting of a user, a device manufacturer, a service provider, an application provider, an application developer, a content owner, and an environment location owner;

7. An electronic device according to claim 6, wherein the processor executes the conflict resolution process to arbitrate among at least two of the stakeholders.

8. An electronic device according to claim 6, wherein the stakeholders further comprise context.

9. An electronic device according to claim 6, wherein context comprises time of day.

10. An electronic device according to claim 1, wherein the processor resolves conflicts among the stakeholder requirements.

11. An electronic device according to claim 10, wherein the processor resolves conflicts among the stakeholder requirements using a priority table within the stakeholder priority certificate.

12. An electronic device according to claim 1, wherein the processor overrides the stakeholder requirements of the priority table.

13. An electronic device according to claim 1, wherein the stakeholder priority certificate comprises a priority sequence for the stakeholders.

14. An electronic device according to claim 13, wherein the processor overrides the priority sequence of the stakeholder priority table.

15. An electronic device according to claim 13, wherein the stakeholder priority certificate further comprises a data indicative of capabilities of the electronic device.

16. An electronic device according to claim 15, wherein the stakeholder priority certificate further comprises data indicative of the stakeholder priority sequence for each capability of the electronic device.

17. An electronic device according to claim 1, wherein the stakeholder priority certificate defining attributes desired for the electronic device comprises the stakeholder priority certificate.

18. An electronic device according to claim 3, wherein the electronic device is selected from a group consisting of a mobile communication electronic device, a digital audio player, a gaming electronic device, and a Personal Digital Assistant (PDA).

19. An electronic device according to claim 3, wherein the certificates are stored in the electronic device.

20. An electronic device according to claim 1, wherein the processor correlates by performing a matching process and subsequently thresholding the result.

21. An electronic device according to claim 1, wherein the processor assures that the stakeholders are legitimate and authorized by checking the authentication signature on each of the stakeholder requirements certificates.

22. An electronic device according to claim 21, wherein the processor checks the authentication signatures in the stakeholder priority certificates to ensure that the priorities are authorized before implementing determined characteristics for the device.

23. An electronic device according to claim 1, wherein the processor derives the stakeholder requirements tables from the stakeholder requirements certificates.

24. An electronic device according to claim 23, wherein the processor derives stakeholder priority sequences from the stakeholder priority certificates and places these this derived stakeholder priority sequences in the stakeholder requirements tables.

25. An electronic device according to claim 23, wherein the processor of the portable device derives the stakeholder priority sequences by collecting priority codes from the stakeholder certificates and ranking the stakeholders relative to one another.

26. An electronic device according to claim 1, further comprising a modem operatively coupled to the memory for receiving the stakeholder priority certificate.
